(19) United States
(12) Patent Application Publication
(10) Pub. No.: US 2005/0287326 A1
(43) Pub. Date: Dec. 29, 2005

(54) Smooth inner bore hose with continuous fluoropolymer liner

(75) Inventors: J Neil Schunke, Marion, NC (US); Eric Alvin Robinson, Marion, NC (US)

Correspondence Address: FITZPATRICK CELLA HARPER & SCINTO, 30 ROCKEFELLER PLAZA, NEW YORK, NY, 10112, US

(73) Assignee: CRANE RESISTOFLEX

(21) Appl. No.: 10/882,105

(22) Filed: Jun. 29, 2004

(51) Int. Cl. B32B 1/08

(52) U.S. Cl. 428/36.91

(57) ABSTRACT

In manufacturing a hose, a liner composed of a polymeric material is provided, as is a rubber outer body. The liner is reduced in diameter, placed into the outer body, and secured to the rubber outer body by thermal treatment.

### BACKGROUND OF THE INVENTION

1. Field of the Invention

This invention relates generally to hoses and tubular conduits, and more particularly to hoses which have a liner made of a polymeric material, particularly of a fluoropolymer.

2. Related Art

Conduits and hoses are essential components of many apparatuses in a wide variety of fields, for example, in biotechnical applications, pharmaceuticals, medicine, etc. In devices used in such fields, it is often important to transport liquids or other fluids in a sanitary manner without contamination.

One of the most basic methods to minimizing process stream contamination is to use a lined hose with a fitting inserted into the bore. To minimize contamination, the wetted surfaces of the fitting are typically encapsulated with a material similar to the liner. Alternatively, the entire fitting may be made of a material similar to the liner. The insertion of the fitting results in a discontinuity in the inner diameter of the hose. This discontinuity can act as a bacteria trap.

In response to the bacteria trap issue, hoses with flared-through fittings were developed. This can eliminate the discontinuity and potential issues of contamination due to wetted fittings. Several hoses that exist today are designed for this purpose. One method for making a hose which is currently in use includes bonding a fluorinated ethylene propylene copolymer (FEP) liner to a rubber shell or carcass with adhesive. The hose may have a number of layers (e.g., rubber, wire reinforcing the rubber, tire cord reinforcing, more rubber, etc.; see U.S. Pat. No. 6,505,649 to Dixon-Roche, for example). Typically, manufacturers of such hoses will initially prepare a predetermined length of hose (e.g., 100 feet). Then, in order to make a smaller hose of custom length, the larger hose is cut to length, and the layers are broken apart in order to insert at least one end fitting between the FEP liner and the rubber carcass. That is, the adhesive bond is purposely broken in order to get down to the FEP liner, which is then flared through the end fitting(s). After this, the flare-through portion is heat-formed.

This method, and a resulting hose made therefrom, can be undesirable for a number of reasons. First, FEP liner is normally whitened through the addition of titanium dioxide, an additive which can leach into fluid streams and effectively contaminate the process. Second, the adhesive itself can be a leaching agent, and can cause contamination.

Another drawback arises from the breaking of the bond in order to get down to the FEP liner, which is then flared through the end fitting(s), after which the flare-through portion is heat-formed. Because adhesive is still present on the outer surface of the FEP liner, when the flare-through portion is heat-formed, not only is the FEP liner being heated, but the adhesive is being heated as well. This can result in the adhesive diffusing through the FEP liner. This results in contamination of the process stream.

There are other drawbacks as well. The method can be quite costly, difficult, and time consuming, and can be especially troublesome if a customer is requesting same-day shipment service. Moreover, performance under full vacuum appears to be unavailable with products that are made using this method, and certain nominal sizes (such as 12 inch or ¾ inch) may be unavailable with this method as well.

Also, conventional methods use etching techniques on the FEP liner as a preparation for the adhesive bonding. Besides adding an extra step to the process, commonly used etchants are dangerous or at least inconvenient to work with.

There exists, therefore, a need for a hose and corresponding methods of making the same which overcome these and other drawbacks associated with prior art hoses and methods. In particular, there is a need for a hose which is capable of transporting fluids in a more sanitary manner.

### SUMMARY OF THE INVENTION

Accordingly, it is an object of the present invention to overcome conventional problems associated with prior art hoses and methods of making the same by providing a hose which is not subject to contamination from leaching such as that described above, which is easier to manufacture, and which does not require the use of etchant and adhesive to manufacture.

To overcome the drawbacks associated with prior art hoses and methods of making the same, in one embodiment a method of manufacturing a hose is provided which does not use etching or adhesive to bond a fluorocarbon liner to a rubber shell. The present invention can substantially reduce the cost, time, and complexity associated with making hoses which are suitable for, for example, sanitary applications. The present invention can also substantially increase or protect the purity of the stream which flows through the hose, and can also provide performance under full vacuum.

One aspect of the present invention is a method of manufacturing a hose. The method includes the steps of providing a liner composed of a polymeric material, providing a rubber outer body, reducing the liner in diameter, preferably by cold drawing or alternatively by hot drawing or by other processes which achieve the desired result, placing the liner into the outer body, and securing the liner to the rubber outer body by thermally treating the liner.

The polymeric material can be a fluoropolymer, preferably polytetrafluoroethylene (PTFE). The step of providing the rubber outer body may include placing a fitting in at least one end of the rubber outer body. Further, in this method, the step of securing the liner may be performed without adhesive, and the step of securing the liner may be performed with the outer surface of the liner unetched.

Another aspect of the present invention is a hose that includes a liner composed of a fluoropolymer and having its outer surface unetched, and at least one fitting. A rubber outer body surrounds the liner, the fitting being positioned in one end of the rubber outer body, the rubber outer body having an inner surface that is directly secured to the unetched outer surface of the liner without the presence of an adhesive material between the rubber outer body and the liner. The hose may have, for example, a nominal diameter of as much as 2 inches or even greater, as well as other sizes.

Another aspect of the present invention is a hose that includes a liner composed of a fluoropolymer, having an unetched outer surface, a rubber outer body surrounding the liner and directly secured to the unetched outer surface of the liner, and at least one end fitting, positioned in one end of the rubber outer body.

Still another aspect of the present invention is a hose that includes a liner composed of a fluoropolymer, a rubber outer body surrounding the liner and directly secured to an outer surface of the liner without an adhesive material, and at least one end fitting, positioned in one end of the rubber outer body.

Yet another aspect of the present invention is a hose that includes a liner composed of a fluoropolymer, at least one fitting having a radiused insertion tip, a rubber outer body surrounding the liner and having an inner surface and an outer surface, and a collar surrounding the outer surface and extending past the insertion tip of the fitting. The fitting is positioned in one end of the rubber outer body and is press fit to a first portion of the inner surface of the rubber outer body by compression of the rubber outer body between the fitting and the collar, and a second portion of the inner surface of the rubber outer body is directly secured to an outer surface of the liner without the presence of an adhesive material between the rubber outer body and the liner, such that an inside diameter of the fitting is substantially equivalent to an inside diameter of the hose so as to maintain a smooth inner bore.

Yet another aspect of the present invention is a method of manufacturing a hose. The method includes the steps of providing a liner composed of a polymeric material, providing an outer body composed of one of an elastomer and a polymer, reducing the liner in diameter and placing the liner into the outer body, and securing the liner to the rubber outer body by thermally treating the liner.

### BRIEF DESCRIPTION OF THE DRAWINGS

These and other aspects of the invention will be more clearly understood by reference to the following detailed description of exemplary embodiments in conjunction with the accompanying drawings, in which:

FIG. 1 illustrates a hose carcass construction according to an embodiment of the present invention;

FIG. 2 illustrates a cross section of a rubber hose with a PTFE liner according to an embodiment of the present invention; and

FIGS. 3A-3C are views of a collar within the rubber hose of FIG. 2.

### DETAILED DESCRIPTION OF THE PREFERRED EMBODIMENTS

The invention will next be described in connection with certain exemplary embodiments; however, it should be clear to those skilled in the art that various modifications, additions, and subtractions can be made without departing from the spirit or scope of the claims.

In a preferred embodiment of the present invention, a rubber hose is provided, having a liner made of a fluoropolymer material, specifically polytetrafluoroethylene (PTFE). One reason PTFE is preferred to FEP is that FEP has an inferior flex life compared to PTFE. PTFE also possesses exceptional resistance to chemical degradation and vapor permeation, and is usable over a broad temperature range. Of course, liners usable in the present invention (as most broadly conceived) are not necessarily limited to PTFE, and other polymer or elastomeric materials may be used as well. Furthermore, other elastomers or even polymers may be used in place of rubber for the hose carcass.

The present invention also provides an assembly process for a PTFE lined rubber hose. In this process, a PTFE liner is prepared, and a rubber shell or carcass is prepared having at least one end fitting. The PTFE liner is then projected through the carcass and end fitting(s) and is flared over the sealing surface. That is, the liner is reduced in diameter, preferably by cold-drawing, or alternatively by hot drawing or by other processes which achieve the desired result, and the liner is drawn into the reinforced rubber shell. It is then thermally “relaxed” to allow it to grow to a very tight fit with the shell.

The resulting internal diameter of the hose assembly can align exactly with the mating fittings commonly used in sanitary applications (for example). That is, there is no internal diameter change where the liquid travels from the hose through the fitting, and thus there is no crevice, niche, or corner to trap bacteria and chemicals. This is referred to as a “Smooth Inner Bore” (SIB) product and is extremely desirable in high purity processes where bacteria traps cannot be tolerated. A hose manufactured in accordance with the present invention can ensure that contaminants do not enter the process stream. Moreover, because the PTFE liner is projected through the end fitting(s) and flared over the sealing surface, no fitting material is “wetted” by the material being conveyed through the hose.

The present invention results in a product which can achieve performance under full vacuum at diameters of up to at least 2 inches. Performance under full vacuum may not be possible in prior art methods which use etching and adhesive bonding.

Another advantage of the present invention is that a hose can be custom made to a specific length more quickly than by using prior art methods, in many cases within the same day, since the present invention does not have the drawback of removing layers from the hose bonded with an inner-liner bonding, and all of the complexities which arise from such.

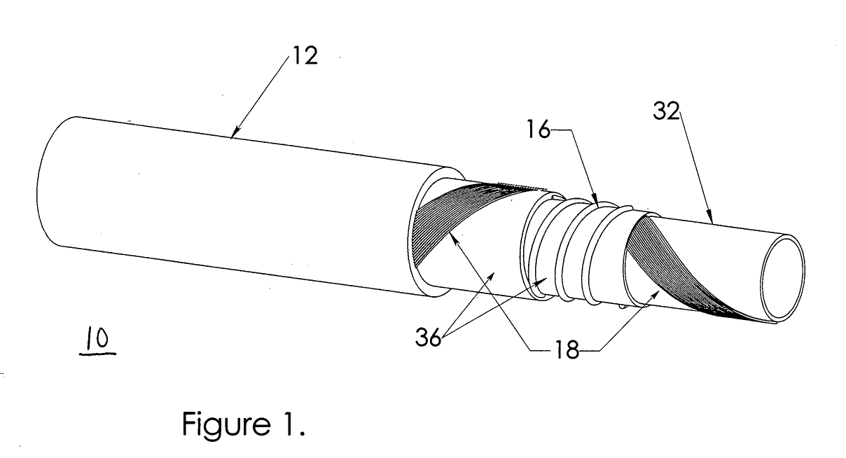

FIG. 1 illustrates the construction of a hose carcass 10. The hose carcass 10 has a cover or outer layer 12 wrapped around rubber layers (reinforced with tire cord, for example). In particular, the hose carcass 10 includes an inner layer 32 and a middle layer 36. Further reinforcement is provided from wire 16 (e.g., carbon steel wire) and reinforcement layers 18 (e.g., polyester tire cord) wrapped in opposite directions. Hose carcasses having the illustrated construction can be manufactured in nominal hose sizes that may not be not available with prior art methods. For example, nominal hose sizes of ½″, ¾″, 1″, 1½″, 2″, or even greater, as well as others, can be provided by the present invention, as can hose carcasses that have inside diameters of, for example, ½″, ¾″, 1″, 1½″, and 2″, as well as others. For the sanitary market, for example, hoses can also be manufactured having inside diameters of, for example, 0.37″, 0.62″, 0.87″, 1.37″, 1.87″, and others.

As discussed above, it is desirable to maintain a smooth inner bore. It is also desirable to achieve a higher burst pressure than has conventionally been possible. The present invention provides a fitting geometry which allows for a higher burst pressure by constraining the expansion of the hose in the area of the transition from the insertion end of the fitting to the general hose. Also, to maintain the smooth inner bore, the inside diameter of the fitting is made to be essentially the same diameter as the hose inside diameter. As such, the fitting is preferably press-fit into the hose carcass. A lubricant, such as P-80®, made by International Products Corporation, may be used to facilitate insertion.

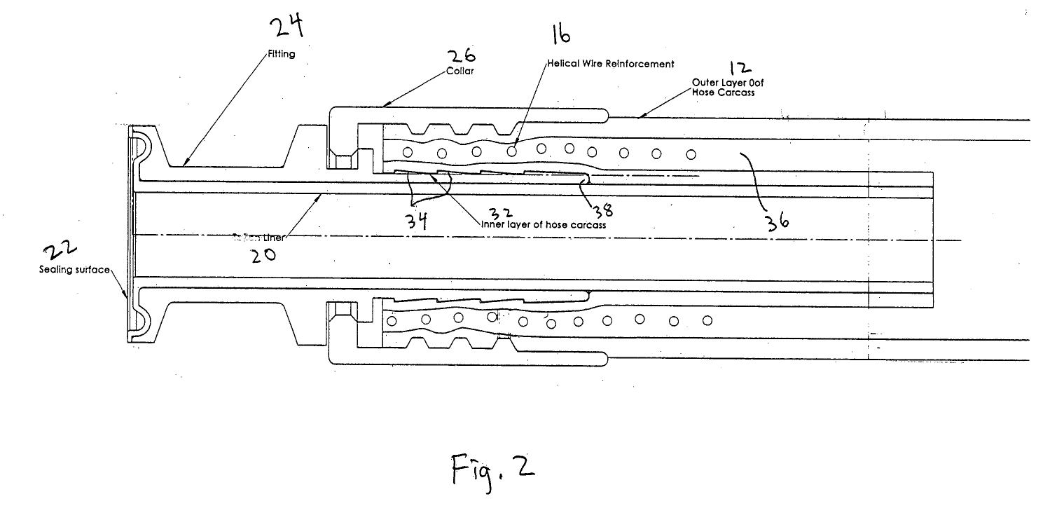

FIG. 2 illustrates a cross-section of the hose of FIG. 1, with a fitting, a collar, and a liner. More particularly, FIG. 2 illustrates a rubber hose with a PTFE liner 20, and shows a flare-through fitting 24 for one type of connection (mini-sanitary). A sealing surface 22 is located near the end of the fitting 24. The PTFE liner 20 is located beneath the fitting 24 (i.e., between the fitting and the axis of the hose), and a collar 26 extends past the length of the fitting 24 (towards the right of the diagram). The fitting has barbs 34 which press-fit the fitting 24 into the inner layer 32 of the hose carcass. The middle layer 36 of the hose carcass is reinforced by helical wire 16. Above the middle layer 36 is the outer layer 12 of the hose carcass. Reference numeral 38 denotes a filling insertion tip, which is preferably rounded. It is noted that the reinforcement layers 18 shown in FIG. 1 are not shown in FIG. 2, although it is understood that these layers are present at the interface between the outer layer 12 and the middle layer 36 of the hose carcass, and at the interface between the middle layer 36 and the inner layer 32 of the hose carcass.

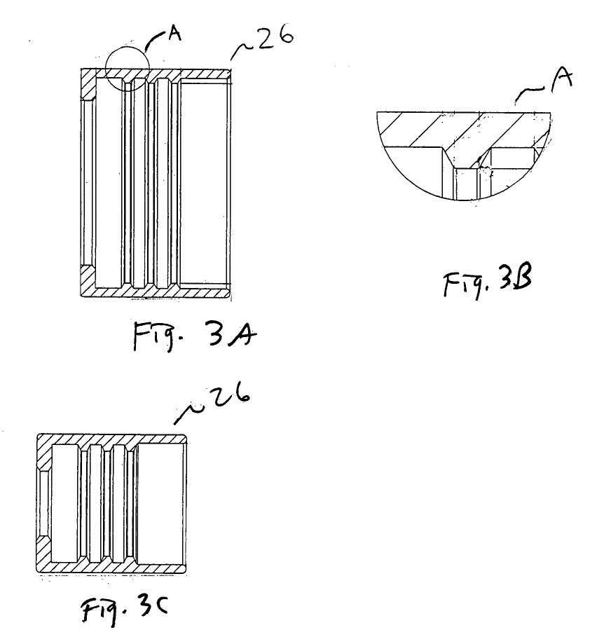

FIGS. 3A and 3C are views of the collar 26 used in the rubber hose of FIG. 2, while FIG. 3B is a view of the section indicated by the letter “A” in FIG. 3A. Fittings may be attached to the hose carcass by either (externally) crimping the collar 26 or by (internally) expanding the fitting 24 such that the hose carcass is compressed between the collar 26 and the fitting 24.

In conventional designs, collars are typically designed to be shorter than the fitting insertion length. The inside diameter of the hose carcass transitions from the fitting outside diameter to its unstressed inside diameter within a relatively short distance. To minimize this distance and facilitate insertion, manufacturers typically design the fitting to be thinner at the insertion point and use a minimal radius at the tip.

One side effect of pressing the fitting into the hose is that the hose is placed under a hoop stress, which acts in the same way as internal pressure. This geometry creates a localized region where a relatively greater expansion of the hose at the fitting insertion point versus pressure occurs, up to the pressure at which the general hose inside diameter is extended to the diameter of the fitting outside diameter (insertion portion of fitting). While this is typically of no particular consequence for standard hoses where the fitting is inserted inside the liner, this can affect burst pressure and reliability for hoses designed with a smooth inner bore where the liner transitions from the inside of the hose to the inside of the fitting, as in the preferred embodiment shown herein. With the liner inside the fitting, and having a lower pressure holding capability than the hose carcass that supports it, the liner will expand with pressure to conform to the shape of the fitting and transitions to the shape of the hose. As the liner is pressurized it will transfer this force to the fitting and the hose carcass, and as the hose carcass is pressurized the inside diameter of the carcass expands relative to the essentially fixed diameter of the hose fitting. This creates a gap between the outside diameter of the fitting and the inside diameter of the expanded hose. The liner being of lower strength would tend to conform to this configuration, extending around the tip of the fitting and into the gap. If the liner material demonstrates hysteresis with elongation, the material would tend to remain elongated and then become pinched as the gap disappears with reduced pressure. This localized stretching (and creasing when pressure is released) is detrimental to the reliability of the hose.

This problem may be reduced by increasing the fitting insertion radius from the typical fractional wall thickness of the fitting (insertion portion) to the full thickness of the wall thickness of the fitting. This can improve burst pressure. The larger radius tends to reduce the localized stress as the liner slips over the edge of the insertion tip and enters the gap. This method does not, however, address the presence of the liner crimped into the gap and the resulting possible bacterial trap.

The present invention has provided a solution to the problem created by this gap, by extending the collar 26 beyond the fitting insertion tip 38 in order to support the outside diameter of the hose past this transition point. By providing support to the outside diameter of the hose carcass past that point, the hose carcass expansion in this region of the assembly can be greatly reduced. By providing a slight compressive stress on the outside diameter of the hose, an ideal point can be reached where the hose carcass is compressed so that it conforms to the shape of the insertion radius to the midpoint of the tip and transitions to the unstressed inside diameter within approximately the radius of the insertion tip. As an example, expressed as a percentage of hose compression a collar 26 inside diameter designed to provide approximately 3% hose compression in this region provides this suitable condition for rubber hose carcasses. Other examples may include from as low as approximately 1% hose compression to as high as approximately 5% hose compression, depending on the particular wire diameters, etc. Too much compression can result in a localized reduction of hose carcass inside diameter contrary to the concept of a smooth inner bore design. It is to be noted that the collar 26 and fitting 24 design should allow for movement of the carcass in the higher regions of compression, otherwise the material will tend to be pushed past the end of the fitting 24, resulting in a localized reduction of the hose carcass inside diameter.

The invention has been described in connection with certain exemplary embodiments. However, it should be clear to those skilled in the art that various modifications, additions, subtractions, and changes in form and details may be made to those embodiments without departing from the spirit or scope of the invention as set forth in the claims below.

1. A method of manufacturing a hose, comprising the steps of:
providing a liner composed of a polymeric material;
providing a rubber outer body;
reducing the liner in diameter, and placing the liner into the outer body; and
securing the liner to the rubber outer body by thermally treating the liner.

2. The method as set forth in claim 1, wherein the polymeric material is a fluoropolymer.

3. The method as set forth in claim 1, wherein the polymeric material is PTFE.

4. The method as set forth in claim 1, wherein said step of providing the rubber outer body includes placing a fitting in at least one end of the rubber outer body.

5. The method as set forth in claim 1, in which said step of securing the liner is performed without adhesive.

6. The method as set forth in claim 5, in which said step of securing the liner is performed with the outer surface of the liner unetched.

7. The method as set forth in claim 1, in which said step of reducing the liner in diameter is performed by cold drawing.

8. The method as set forth in claim 1, in which said step of reducing the liner in diameter is performed by hot drawing.

9. A hose, comprising:
a liner composed of a fluoropolymer and having its outer surface unetched;
at least one fitting; and
a rubber outer body surrounding the liner, said fitting being positioned in one end of the rubber outer body, the rubber outer body having an inner surface that is directly secured to the unetched outer surface of the liner without the presence of an adhesive material between the rubber outer body and the liner.

10. A hose, comprising:
a liner composed of a fluoropolymer, having an unetched outer surface;
a rubber outer body surrounding the liner and directly secured to the unetched outer surface of the liner; and
at least one end fitting, positioned in one end of the rubber outer body.

11. A hose, comprising:
a liner composed of a fluoropolymer;
a rubber outer body surrounding the liner and directly secured to an outer surface of the liner without an adhesive material; and
at least one end fitting, positioned in one end of the rubber outer body.

12. A hose, comprising:
a liner composed of a fluoropolymer;
at least one fitting having a radiused insertion tip;
a rubber outer body surrounding the liner and having an inner surface and an outer surface; and
a collar surrounding the outer surface and extending past the insertion tip of the fitting,
wherein the fitting is positioned in one end of the rubber outer body and is press fit to a first portion of the inner surface of the rubber outer body by compression of the rubber outer body between the fitting and the collar, and
a second portion of the inner surface of the rubber outer body is directly secured to an outer surface of the liner without the presence of an adhesive material between the rubber outer body and the liner, such that an inside diameter of the fitting is substantially equivalent to an inside diameter of the hose so as to maintain a smooth inner bore.

13. A method of manufacturing a hose, comprising the steps of:
providing a liner composed of a polymeric material;
providing an outer body composed of one of an elastomer and a polymer;
reducing the liner in diameter, and placing the liner into the outer body; and
securing the liner to the rubber outer body by thermally treating the liner.
